(19) United States
(12) Patent Application Publication
(10) Pub. No.: US 2003/0095194 A1
(43) Pub. Date: May 22, 2003

(54) Electronic apparatus having function of accommodating accessory devices

(75) Inventors: Akihiro Suzuki, Tokyo (JP); Yoshito Katagiri, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Corporation, Tokyo (JP)

(21) Appl. No.: 10/295,296

(22) Filed: Nov. 15, 2002

(30) Foreign Application Priority Data
Nov. 22, 2001 (JP) 2001-357655

(51) Int. Cl. H04N 5/76

(52) U.S. Cl. 348/231.99

(57) ABSTRACT

There is described an electronic apparatus, such as a digital camera, which accommodates two kinds of accessory devices, for instance, a first memory device and a second memory device, standards of which are different relative to each other. The electronic apparatus has a function of electronically performing a data transaction with the first memory device and the second memory device and is provided with an accommodating section for accommodating either the first memory device or the second memory device, shapes of which are different each other. The electronic apparatus includes a first accommodating region to detachably accommodate the first memory device and a second accommodating region to detachably accommodate the second memory device. The accommodating section includes both the first accommodating region and the second accommodating region, and a part of the first accommodating region overlaps with a part of the second accommodating region.

### BACKGROUND OF THE INVENTION

The present invention relates to an electronic apparatus, which detachably accommodates two kinds of storage devices, standards of which are different relative to each other and into which data can be stored.

Recently, small-sized potable apparatus, such as PDAs (Personal Digital Assistant), digital cameras, etc., have been widely proliferating in the market. Such a small-sized potable apparatus comprises a detachable semiconductor storage device, into/from which prescribed digital data are stored/read in response to the command signals inputted by the operator.

Since such the semiconductor storage devices are shaped like a card, each of them is generally called as a “memory card”. Various kinds of memory cards having different standards (including dimensional specifications), for instance, such as a Smart Media in which a flash memory is packaged and its connecting terminal is exposed outside the card surface, a CF (Compact Flash; a registered trademark) card and a Memory Stick (a registered trademark), each of which incorporates a memory controller to insure interchangeability between different apparatus, a SD (Secure Digital; a registered trademark) card having a function of protecting its copy right, etc., are available in the current market.

Incidentally, the dimensional specifications detailed in the following are included in the standards of the memory cards.

Recently, there has developed a small-sized potable apparatus, which make it possible to read/write data from/into two types of memory cards having different standards each other. Such the small-sized potable apparatus is provided with two card slots, each of which individually fits to the standard for each of the two memory cards, and each of the two memory cards are individually accommodated into the suitable card slot to perform a data-reading operation or a data-recording operation.

With respect to the conventional small-sized potable apparatus mentioned above, however, there has been the following problem. Concretely speaking, despite that it is desirable that the small-sized potable apparatus is as thin and light as possible so as to improve its portability, in the abovementioned small-sized potable apparatus, which is provided with the two card slots having the different standards each other, an area or a thickness equivalent to that for at least two cards is required for accommodating them in it. Therefore, with respect to the small-sized potable apparatus, which make it possible to employ two types of memory cards, there have been dimensional limitations for minimizing the volume and thickness of the apparatus as mentioned above.

### SUMMARY OF THE INVENTION

To overcome the abovementioned drawbacks in conventional electronic apparatus, it is an object of the present invention to provide an electronic apparatus, for instance, such as a digital camera, which detachably accommodates two types of memory devices and is capable of storing data in anyone of the memory devices, and which makes it possible to improve its portability by reducing the thickness of the card slot thinner than the total thickness of the two types of memory devices, even if the electronic apparatus is so constituted that the two types of memory devices are usable.

Accordingly, to overcome the cited shortcomings, the abovementioned object of the present invention can be attained by electronic apparatus and digital cameras described as follow.

(1) An apparatus, having a function of electronically performing a data transaction with a first memory device and a second memory device and having an accommodating section for accommodating either the first memory device or the second memory device, shapes of the first and second memory devices being different each other, comprising: a first accommodating region to detachably accommodate the first memory device; and a second accommodating region to detachably accommodate the second memory device; wherein the accommodating section includes both the first accommodating region and the second accommodating region, and a part of the first accommodating region overlaps with a part of the second accommodating region.

(2) The apparatus of item 1, further comprising: an accommodating error preventive element to prevent the first memory device from proceeding into the second accommodating region, and to also prevent the second memory device from proceeding into the first accommodating region, based on dimensional difference between the shapes of the first memory device and the second memory device.

(3) The apparatus of item 1, further comprising: a plate member to divide the accommodating section into the first accommodating region and the second accommodating region; wherein, when the first memory device is accommodated in the first accommodating region, the plate member moves in response to an inserting action of the first memory device so as to form the first accommodating region, while, when the second memory device is accommodated in the second accommodating region, the plate member moves in response to an inserting action of the second memory device so as to form the second accommodating region.

(4) The apparatus of item 1, wherein each of the first memory device and the second memory device is shaped in a card, and, shapes and sizes of the first and the second memory devices are different relative to each other.

(5) The apparatus of item 1, further comprising: a first connecting terminal to which the first memory device is coupled; and a second connecting terminal to which the second memory device is coupled.

(6) The apparatus of item 2, further comprising: a first connecting terminal to which the first memory device is coupled; and a second connecting terminal to which the second memory device is coupled; wherein the accommodating error preventive element prevents the first memory device from being coupled to the second connecting terminal, and prevents the second memory device from being coupled to the first connecting terminal.

(7) A digital camera, having a function of electronically performing a data transaction with a first memory device and a second memory device and having an accommodating section for accommodating either the first memory device or the second memory device, shapes of the first and second memory devices being different each other, comprising: a first accommodating region to detachably accommodate the first memory device; and a second accommodating region to detachably accommodate the second memory device; wherein the accommodating section includes both the first accommodating region and the second accommodating region, and a part of the first accommodating region overlaps with a part of the second accommodating region.

(8) The digital camera of item 7, further comprising: an accommodating error preventive element to prevent the first memory device from proceeding into the second accommodating region, and to also prevent the second memory device from proceeding into the first accommodating region, based on dimensional difference between the shapes of the first memory device and the second memory device.

(9) The digital camera of item 7, further comprising: a plate member to divide the accommodating section into the first accommodating region and the second accommodating region; wherein, when the first memory device is accommodated in the first accommodating region, the plate member moves in response to an inserting action of the first memory device so as to form the first accommodating region, while, when the second memory device is accommodated in the second accommodating region, the plate member moves in response to an inserting action of the second memory device so as to form the second accommodating region.

(10) The digital camera of item 7, wherein each of the first memory device and the second memory device is shaped in a card, and, shapes and sizes of the first and the second memory devices are different relative to each other.

(11) The digital camera of item 7, further comprising: a first connecting terminal to which the first memory device is coupled; and a second connecting terminal to which the second memory device is coupled.

(12) The digital camera of item 8, further comprising: a first connecting terminal to which the first memory device is coupled; and a second connecting terminal to which the second memory device is coupled; wherein the accommodating error preventive element prevents the first memory device from being coupled to the second connecting terminal, and prevents the second memory device from being coupled to the first connecting terminal.

(13) An electronic apparatus, in which an electronic power current is supplied from at least one of a first battery and a second battery, shapes of the first and second batteries being different each other, comprising: an accommodating section to accommodate either the first battery or the second battery; a first connecting terminal to which the first battery is coupled; and a second connecting terminal to which the second battery is coupled; wherein the accommodating section comprises: a first accommodating region to detachably accommodate the first battery coupled to the first connecting terminal; and a second accommodating region to detachably accommodate the second battery coupled to the second connecting terminal; and wherein a part of the first accommodating region overlaps with a part of the second accommodating region.

(14) The electronic apparatus of item 13, wherein the electronic apparatus is a digital camera.

(15) The electronic apparatus of item 13, further comprising: an accommodating error preventive element to prevent the first memory device from proceeding into the second accommodating region, and to also prevent the second memory device from proceeding into the first accommodating region, based on dimensional difference between the shapes of the first memory device and the second memory device.

(16) The electronic apparatus of item 13, further comprising: a plate member to divide the accommodating section into the first accommodating region and the second accommodating region; wherein, when the first battery is accommodated in the first accommodating region, the plate member moves in response to an inserting action of the first battery so as to form the first accommodating region, while, when the second battery is accommodated in the second accommodating region, the plate member moves in response to an inserting action of the second battery so as to form the second accommodating region.

(17) An electronic apparatus, in which a first accessory device and a second accessory device, shapes of which are different each other, can be selectively and detachably accommodated, the electronic apparatus comprising: an accommodating section to accommodate either the first accessory device or the second accessory device; a first connecting terminal to which the first accessory device is coupled; and a second connecting terminal to which the second accessory device is coupled; wherein the accommodating section comprises: a first accommodating region to accommodate the first accessory device coupled to the first connecting terminal; and a second accommodating region to accommodate the second accessory device coupled to the second connecting terminal; and wherein a part of the first accommodating region overlaps with a part of the second accommodating region.

(18) The electronic apparatus of item 17, wherein the electronic apparatus is a digital camera.

(19) The electronic apparatus of item 17, further comprising: an accommodating error preventive element to prevent the first accessory device from erroneously proceeding into the second accommodating region and being coupled to the second connecting terminal, and to also prevent the second accessory device from erroneously proceeding into the first accommodating region and being coupled to the first connecting terminal, based on dimensional difference between the shapes of the first accessory device and the second accessory device.

(20) The electronic apparatus of item 17, further comprising: a plate member to divide the accommodating section into the first accommodating region and the second accommodating region; wherein, when the first accessory device is accommodated in the first accommodating region, the plate member moves in response to an inserting action of the first accessory device so as to form the first accommodating region, while, when the second accessory device is accommodated in the second accommodating region, the plate member moves in response to an inserting action of the second accessory device so as to form the second accommodating region.

Further, to overcome the abovementioned problems, other electronic apparatus, embodied in the present invention, will be described as follow:

(21) An electronic apparatus, characterized in that,

in the electronic apparatus provided with an accommodating section in which a first memory and a second memory, having card-shapes different relative to each other, are detachably accommodated,

an accommodating region in the accommodating section comprises a first accommodating region to accommodate the first memory and a second accommodating region to accommodate the second memory, and a part of the first accommodating region overlaps with a part of the second accommodating region.

Accordingly, since the thickness of the card slot (the accommodating section) can be reduced thinner than the total thickness of the first memory card and the second memory card, it becomes possible to minimize the size of the card slot, resulting in the improvement of the portability of the apparatus.

(22) The electronic apparatus, described in item 21, characterized in that,

the size and the shape of the first memory are different from those of the second memory, and

an inserting error preventive means, for preventing the first memory from proceeding into the second accommodating region, and for also preventing the second memory from proceeding into the first accommodating region, is provided.

According to the above, the size and the shape of the first memory are different from those of the second memory, and an inserting error preventive means prevents the first memory from proceeding into the second accommodating region, and also prevents the second memory from proceeding into the first accommodating region, based on the differences in the size and the shape between the first memory and the second memory.

It becomes possible to prevent the first memory and the second memory or the connecting terminal, etc. equipped in the accommodating section from damages caused by the erroneously accommodating the first memory or the second memory into the wrong accommodating region.

(23) The electronic apparatus, described in item 21, characterized in that,

a plate member, to divide the accommodating section into the first accommodating region and the second accommodating region, is provided movably, and

when the first memory is accommodated in the first accommodating region, the plate member moves in response to an inserting action of the first memory so as to form the first accommodating region, while, when the second memory is accommodated in the second accommodating region, the plate member moves in response to an inserting action of the second memory so as to form the second accommodating region.

Accordingly, although a first connecting terminal and a second connecting terminal are provided in the first accommodating region and the second accommodating region so as to be respectively coupled to the first memory and the second memory, it becomes possible to prevent the second connecting terminal from wearing off or being damaged by erroneously contacting the first memory when inserting the first memory, since the second connecting terminal is protected by the plate member when accommodating the first memory, and in the same manner, it becomes possible to prevent the first connecting terminal from wearing off or being damaged by erroneously contacting the second memory when inserting the second memory, since the first connecting terminal is protected by the plate member when accommodating the second memory.

### BRIEF DESCRIPTION OF THE DRAWINGS

Other objects and advantages of the present invention will become apparent upon reading the following detailed description and upon reference to the drawings in which:

FIG. 1 shows a perspective view of the outlook of digital camera 100, serving as a first example embodied in the present invention;

FIG. 2 shows a block diagram of the internal configuration of digital camera 100, serving as a first example embodied in the present invention;

FIG. 3 shows an area, for accommodating the memory cards, provided in card slot 10 shown in FIG. 1;

FIG. 4 shows a perspective view of the internal structure of card slot 10 shown in FIG. 1;

FIG. 5 shows a plane view of the internal structure of card slot 10 shown in FIG. 1; and

FIG. 6 shows a cross sectional view of an internal structure of the card slot, provided with digital camera 200, serving as a second example embodied in the present invention.

### DETAILED DESCRIPTION OF THE PREFERRED EMBODIMENT

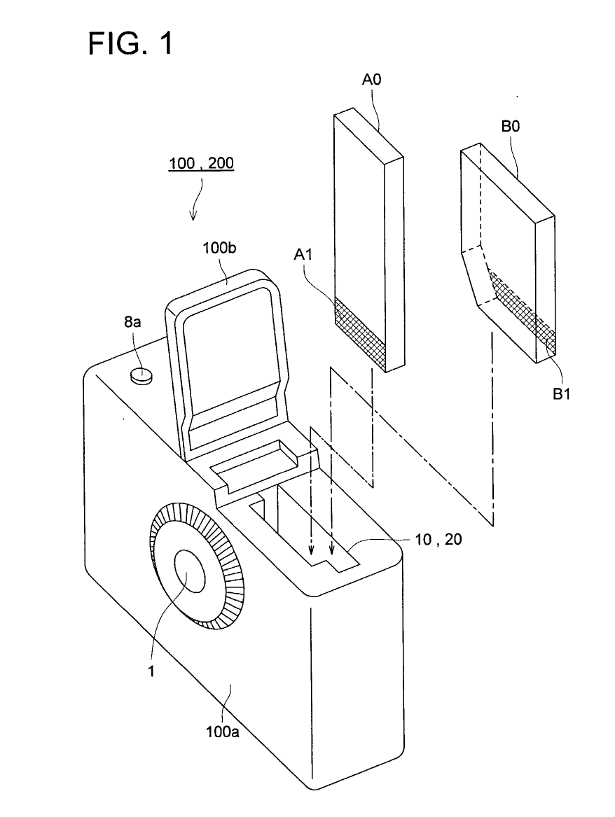

Referring to FIG. 1-FIG. 5, a desirable example, embodied in the present invention, will be detailed in the following.

### FIRST EXAMPLE

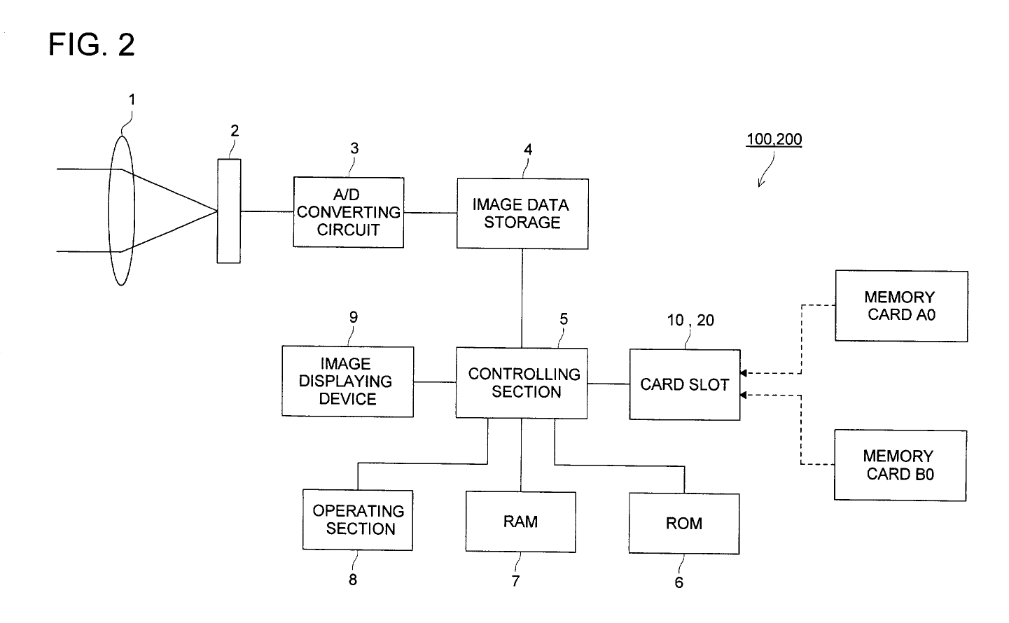

Initially, the configuration of digital camera 100, embodied in the present invention, will be detailed in the following. FIG. 1 shows a perspective view of digital camera 100, and FIG. 2 shows a block diagram of the internal configuration of digital camera 100.

As shown in FIG. 1, digital camera 100 comprises photographic lens 1, etc., disposed on the front surface section of casing body 100a, shutter release button 8a disposed at the upper side section of casing body 100a for commanding a shooting operation, card slot 10 (detailed later) accommodating memory card A0 or memory card B0 so as to read/write the data from/into each of them, and card slot lid 100b, which is opened and closed when inserting/removing memory card A0 or B0. Further, a liquid-crystal display (not shown in the drawings), equipped in image displaying device 9 (detailed later), is disposed at the rear surface section opposite the front surface section of casing body 100a, in order to display the photographed image acquired through photographic lens 1 on it.

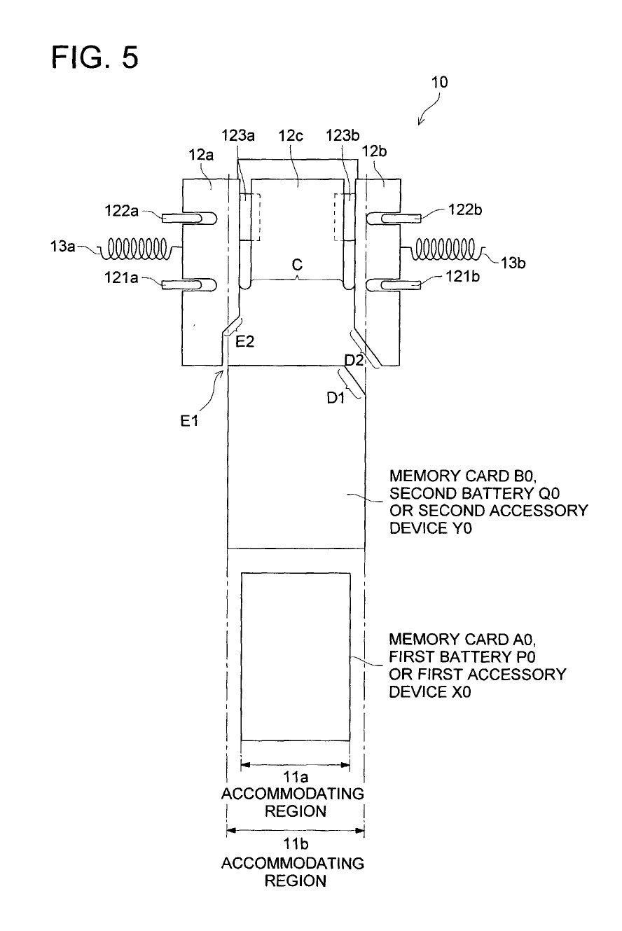

Incidentally, with respect to the following explanation for digital camera 100 embodied in the present invention, it is assumed that memory card A0 is a memory stick (having dimensions of thickness; 2.8 mm, width; 21.5 mm, length; 50 mm), and memory card B0 is a SD card (having dimensions of thickness; 2.1 mm, width; 24 mm, length; 32 mm). Of course, however, other memory cards having different dimensional standards would be also applicable for this assumption. Further, for simplicity of the drawings, or for emphasizing the function of every part of them, the dimensional shapes of memory card A0 and memory card B0, depicted in FIG. 1- FIG. 5, do not necessary coincide strictly with the real dimensional shapes of them.

FIG. 2 shows the internal configuration of digital camera 100, which comprises photographic lens 1, CCD 2 (Charge Coupled Device), A/D converting circuit 3 (Analogue to Digital converting circuit), image data storage 4, controlling section 5, ROM 6 (Read Only Memory), RAM 7 (Random Access Memory), operating section 8, image displaying device 9, card slot 10, etc.

The optical image of the subject is focused onto CCD 2 by photographic lens 1. Then, CCD 2 converts the optical image signals focused onto photosensitive area of CCD 2 by photographic lens 1 to the electronic image signals (analogue signals). Further, A/D converting circuit 3 converts the electronic image signals inputted from CCD 2 to the digital signals, serving as digital image data of the optical image, which are temporarily stored in image data storage 4.

When the electronic power (not shown in the drawings) is turned ON, controlling section 5 readouts the main-control programs for controlling the operations of digital camera 100 from ROM 6 (detailed later) to execute them, and further, in response to the command signal inputted through operating section 8, controlling section 5 conducts processing operations in various kinds of photographing modes, etc., pertaining to the main-control programs. In addition, controlling section 5 stores various kinds of data, generated during the executing process of the programs, in a predetermined memory area of the in-house storage section (not shown in the drawings).

Controlling section 5 includes a processing circuit and a compression circuit (both not shown in the drawings). The processing circuit converts the digital image signals inputted from A/D converting circuit 3 to the video signals including luminance signals, chrominance signals, chroma signals, etc., while the compression circuit compresses the video signals, outputted by the processing circuit, based on a compression protocol, such as the JPEG (Joint Photographic Experts Group), etc.

ROM (Read Only Memory) 6 stores in advance the various kinds of controlling programs, various data required at the time of executing the programs concerned, etc. in it. RAM (Random Access Memory) 7 provided with a program storage area and a data storage area (both not shown in the drawings). When executing the various kinds of processing programs mentioned above, controlling section 5 develops the program concerned in the program storage area, and temporarily stores the data generated during executing the various kinds of processing programs mentioned above in the data storage area.

Operating section 8 includes shutter release button 8a for commanding the photographing operation, etc. When shutter release button 8a is pushed down, a command signal for instructing the photographing operation is outputted to controlling section 5. Further, image-displaying device 9 includes the LCD (the liquid-crystal display), etc., so as to display the images based on the displaying signals inputted from controlling section 5. In addition, image displaying device 9 also serves as a finder, which continuously displays the photographic images captured by CCD 2.

Card slot 10 accommodates either memory card A0 or memory card B0, and includes a first connecting terminal to which connecting terminal A1 of memory card A0 is coupled so as to read/write the data when memory card A0 is loaded into card slot 10, and a second connecting terminal to which connecting terminal B1 of memory card B0 is coupled so as to read/write the data when memory card B0 is loaded into card slot 10.

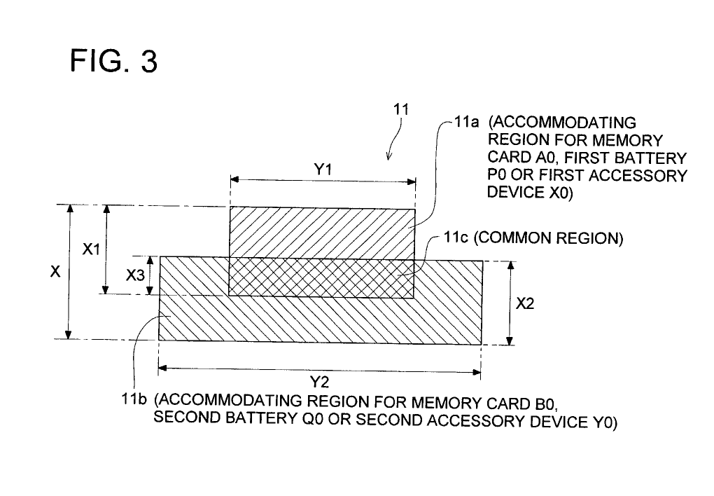

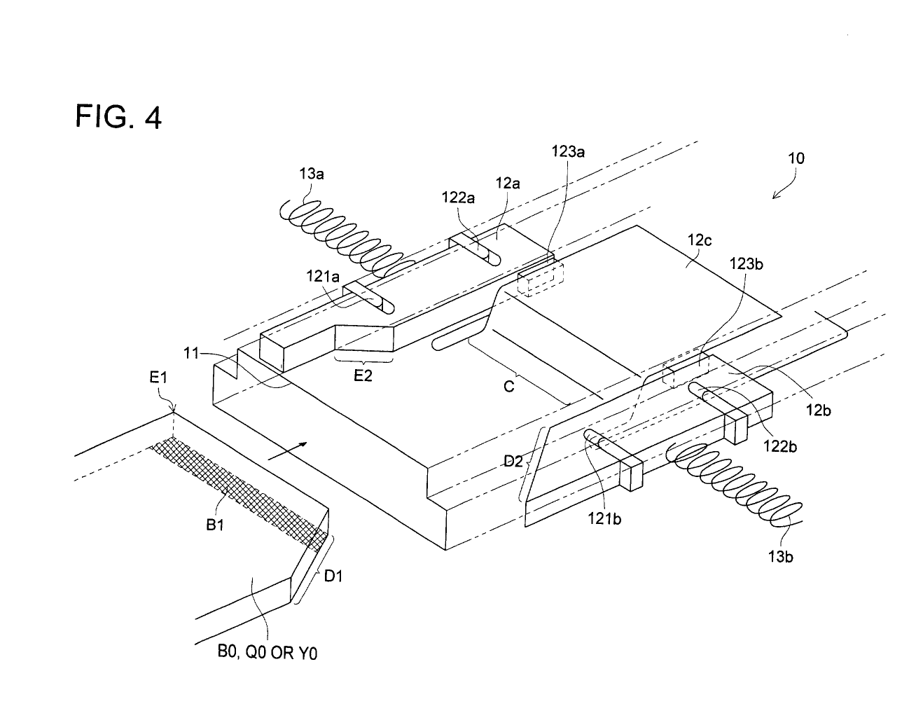

Now, referring to the FIG. 3-FIG. 5, card slot 10 will be detailed in the following. FIG. 3 shows an area, for accommodating the memory cards, provided in card slot 10, FIG. 4 shows a perspective view of the internal structure of card slot 10 and FIG. 5 shows a plane view of the internal structure of card slot 10.

As shown in FIG. 3, accommodating region 11a, having substantially the same dimensions as those of memory card A0 (thickness X1; about 2.8 mm, width Y1; about 21.5 mm), for accommodating memory card A0 and accommodating region 11b, having substantially the same dimensions as those of memory card B0 (thickness X2; about 2.1 mm, width Y2; about 24 mm), for accommodating memory card B0 are provided in card slot 10. Further, accommodating region 11a and accommodating region 11b are disposed in card slot 10, in such a manner that the both regions 11a and 11b must overlap each other at common region 11c (having dimensions of thickness X3, width Y1).

Accordingly, card inserting opening 11, from which memory card A0 or B0 is inserted into card slot 10, has a rectangular shape as shown in FIG. 1 and FIG. 3.

Thickness X of card slot 10 can be found by subtracting thickness X3 of common region 11c the summed value of X1+X2, in which X1 is the thickness of memory card A0 while X2 is the thickness of memory card B0. In other words, since the thickness of card slot 10 is shorter than the total value of X1+X2, such the dimensional restriction does not allow card slot 10 to accommodate memory card A0 and memory card B0 at the same time.

Further as aforementioned, in card slot 10, the first connecting terminal (not shown in the drawings), to which connecting terminal A1 of memory card A0 is coupled so as to conduct the data-communicating operation when memory card A0 is accommodated into card slot 10, is disposed in accommodating region 11a, and the second connecting terminal (not shown in the drawings), to which connecting terminal B1 of memory card B0 is coupled so as to conduct the data-communicating operation when memory card B0 is accommodated into card slot 10, is disposed in accommodating region 11b. Both the first and second connecting terminals disposed in accommodating regions 11a, 11b are coupled to controlling section 5.

As shown in FIG. 4, card slot 10 comprises card-discriminating keys 12a, 12b, which are disposed at both sides in accommodating region 11b so as to be activated when memory card B0 is inserted along the both sides in accommodating region 11b, and inserting-error preventive key 12c disposed at an inner position of the central part being a continued section from card inserting opening 11.

Card-discriminating key 12a can freely slide in a direction guided by sliding guide 121a, 122a (namely, in a direction substantially perpendicular to the inserting direction of the memory card), while card-discriminating key 12b can freely slide in a direction guided by sliding guide 121b, 122b. Further, card-discriminating keys 12a, 12b are coupled to coil springs 13a, 13b so as to urge them in a direction of clipping inserting-error preventive key 12c (in other words, in such a direction that card-discriminating keys 12a, 12b approach relative to each other).

Further, each of card-discriminating keys 12a, 12b comprises each of supporting sections 123a, 123b for supporting inserting-error preventive key 12c so as to form accommodating region 11a.

Inserting-error preventive key 12c is elastically deformable around the periphery of the boundary at the bottom surface of card slot 10, indicated by letter “C”, (namely, it deforms when an external force is applied to inserting-error preventive key 12c). Further, inserting-error preventive key 12c is formed in such a shape that it is located at slightly upper position, compared to the positions of supporting sections 123a, 123b when an external force is not applied to inserting-error preventive key 12c. Accordingly, supporting sections 123a, 123b of card-discriminating keys 12a, 12b, urged by coil springs 13a, 13b, are inserted beneath inserting-error preventive key 12c so as to make it possible to support inserting-error preventive key 12c, when an external force is not applied to inserting-error preventive key 12c.

Further, as shown in FIG. 5, since the width Y1 of accommodating region 11a (namely, the width of memory card A0) is smaller than the width between card-discriminating keys 12a, 12b, memory card A0 can be smoothly inserted into accommodating region 11a, which is formed within a special region between card-discriminating keys 12a, 12b (namely, the special region formed above inserting-error preventive key 12c).

Accordingly, when memory card A0 is accommodated into accommodating region 11a, inserting-error preventive key 12c serves as a supporting plate for smoothly accommodating memory card A0 therein. As a result, connecting terminal A1 is coupled to the first connecting terminal disposed in accommodating region 11a. Since inserting-error preventive key 12c is supported by supporting sections 123a, 123b, it is not pushed down by the inserting action for memory card A0, and therefore, memory card A0 can be surely accommodated into accommodating region 11a.

Further, when memory card B0 is accommodated into accommodating region 11b, end corner section D1 of memory card B0 initially contacts side surface section D2 of card-discriminating key 12b. Then, associating with the progress of memory card B0, supporting card-discriminating key 12b and supporting section 123b moves against the urging force generated by coil spring 13b in a direction (an outward direction) guided by sliding guides 121b, 122b, and thereafter, another end corner section E1 of memory card B0 contacts side surface section E2 of card-discriminating key 12a. Next, associating with the further progress of memory card B0, supporting card-discriminating key 12a and supporting section 123a moves against the urging force generated by coil spring 13a in a direction (an outward direction) guided by sliding guides 121a, 122a.

When memory card B0 is further inserted into accommodating region 11b, an external force generated by this inserting action is exerted onto inserting-error preventive key 12c. Since supporting sections 123a, 123b are moved outside at this moment, inserting-error preventive key 12c is bended and pushed down in response to the external force. As a result, memory card B0 can further progress into the inner side of accommodating region 11b, and finally, connecting terminal B1 is coupled to the second connecting terminal disposed in accommodating region 11b.

In other words, card slot 10 accommodates memory card A0 in accommodating region 11a so as to make it possible to read/write the data, and also accommodates memory card B0 in accommodating region 11b so as to make it possible to read/write the data.

Further, card slot 10 has a preventive function for preventing memory card A0 from erroneously accommodating in accommodating region 11b for memory card B0, and for also preventing memory card B0 from erroneously accommodating in accommodating region 11a for memory card A0. This preventive function will be detailed in the following.

At first, since the width Y2 of memory card B0 is larger than the width Y1 of accommodating region 11a, it never happens that memory card B0 is erroneously accommodated into accommodating region 11a.

Further, when memory card A0 is accommodated into accommodating region 11b, memory card A0 can progress into accommodating region 11a until it is batted against inserting-error preventive key 12c (memory card A0 does not contact card-discriminating keys 12a, 12b, or does not contact card-discriminating keys 12a, 12b at the same time). However, since memory card A0 does not contact card-discriminating keys 12a, 12b (or does not contact card-discriminating keys 12a, 12b at the same time), supporting sections 123a, 123b cannot be simultaneously withdrawn from inserting-error preventive key 12c. Accordingly, since memory card A0 does not push down inserting-error preventive key 12c but is merely batted against inserting-error preventive key 12c, it never happens that memory card A0 is erroneously accommodated into accommodating region 11b.

Therefore, according to card slot 10 embodied in the present invention, it becomes possible to discriminate the dimensional difference between two memory cards by introducing card inserting opening 11 having the shape shown in FIG. 3 and card-discriminating keys 12a, 12b, and it also becomes possible to prevent the two memory cards from erroneously accommodating in card slot 10 by introducing inserting-error preventive key 12c.

As described in the foregoing, card slot 10 of digital camera 100, being the first example embodied in the present invention, comprises accommodating region 11a for accommodating memory card A0, accommodating region 11b for accommodating memory card B0 and common region 11c at which accommodating region 11a and accommodating region 11b overlap each other. In addition, the thickness X of card slot 10 is smaller by the thickness X3 of common region 11c than the total thickness of X1+X2 in which the thickness of memory card A0 (the thickness of accommodating region 11a) is X1 and the thickness of memory card B0 (the thickness of accommodating region 11b) is X2.

Further, although dimensions and shapes of memory card A0 and memory card B0 are different each other, card slot 10 has a function (a preventive function) for preventing memory card A0 from erroneously accommodating in accommodating region 11b for memory card B0, or for preventing memory card B0 from erroneously accommodating in accommodating region 11a for memory card A0.

Concretely speaking, since the width Y1 of accommodating region 11a is smaller than the width Y2 of memory card B0, it is impossible to accommodate memory card B0 in accommodating region 11a, even if the user tries to load memory card B0 into accommodating region 11a for memory card A0.

Further, since memory card A0 does not contact card-discriminating keys 12a, 12b (or does not contact card-discriminating keys 12a, 12b at the same time), supporting sections 123a, 123b cannot be simultaneously withdrawn from inserting-error preventive key 12c, even if the user tries to load memory card A0 into accommodating region 11b for memory card B0. Accordingly, since memory card A0 does not push down inserting-error preventive key 12c but is merely batted against inserting-error preventive key 12c, it is impossible to accommodate memory card A0 in accommodating region 11b.

Accordingly, since the thickness X of card slot 10 is smaller than the total thickness of thickness X1 of memory card A0 and thickness X2 of memory card B0, it becomes possible to make the outer thickness of the main body of digital camera 100 further thinner than ever, resulting in an improvement of the portability of digital camera 100.

Further, because of the function for preventing memory cards A0, B0 from erroneously loaded in card slot 10, each of memory cards A0, B0 can be surely accommodated in each of accommodating regions 11a, 11b. Accordingly, it never happens that memory cards A0, B0 themselves, connecting terminals A1, B1 equipped on memory cards A0, B0 or the first and second connecting terminals provided in card slot 10 are damaged by erroneously loading one of memory cards A0, B0 into a wrong accommodating region.

Still further, since the structure of card slot 10, embodied in the present invention, does not allow to simultaneously accommodate memory cards A0, B0 into it, the UI (User Interface) would be simplified.

### SECOND EXAMPLE

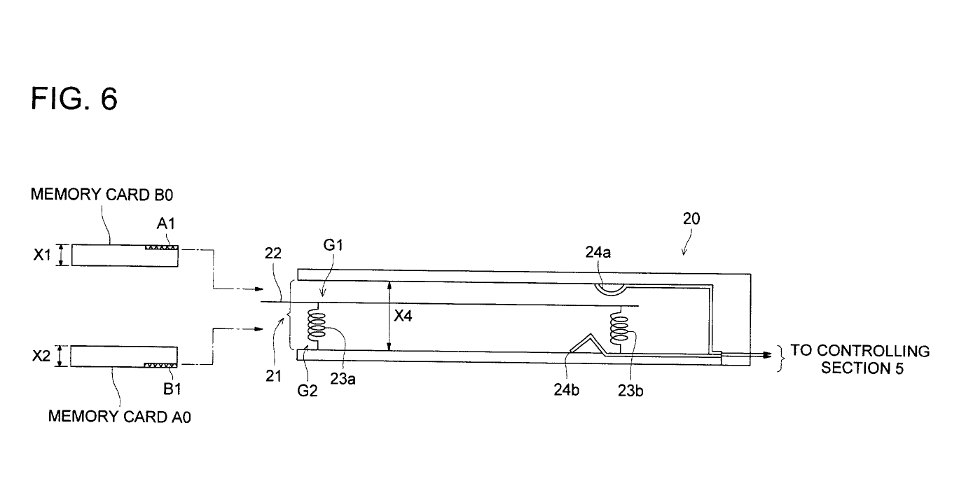

Next, referring to FIG. 6, digital camera 200, serving as a second example embodied in the present invention, will be detailed in the following.

The configuration of digital camera 200 is substantially the same as that of digital camera 100, except that digital camera 200 comprises card slot 20 instead of card slot 10. Accordingly, with respect to the explanation for digital camera 200, serving as a second example embodied in the present invention, only the configuration of card slot 20 will be detailed in the following, and therefore, with respect to the other structural elements, the detailed explanations for them will be omitted by attaching the same reference numerals as those for digital camera 100 (refer to FIG. 1 and FIG. 2).

Further, it is assumed that memory cards A0, B0 to be accommodated in card slot 20 are the same as those employed in the first example, namely, it is assumed in the following explanation that memory card A0 is a memory stick while memory card B0 is a SD card. Of course, however, other memory cards having different dimensional standards would be also applicable for this assumption.

FIG. 6 shows a cross sectional view of the internal configuration of card slot 20 equipped in digital camera 200.

As shown in FIG. 6, in card slot 20, coil springs 23a, 23b support plate member 22, so that plate member 22 is located around the center region of card slot 20. Accordingly, the inner space of card slot 20 is divided into upper region G1 and lower region G2 by plate member 22, and some portion of plate member 22 is protruded from inserting opening 21.

In the above configuration, memory card A0 is inserted into upper region G1, while memory card B0 is inserted into lower region G2. In other words, in card slot 20, connecting terminal 24a, which is coupled to connecting terminal A1 of memory card A0 to conduct bilateral data-communication between them, is disposed in upper region G1 of plate member 22, while connecting terminal 24b, which is coupled to connecting terminal B1 of memory card B0 to conduct bilateral data-communication between them, is disposed in lower region G2 of plate member 22, and both are coupled to controlling section 5.

Thickness (height) X4 of the inner space of card slot 20 is smaller than the total value of X1+X2, in which X1 is the thickness of memory card A0 while X2 is the thickness of memory card B0. In other words, when memory card A0 is accommodated in card slot 20, the space sufficient for accommodating memory card B0 cannot be formed in lower region G2, while when memory card B0 is accommodated in card slot 20, the space sufficient for accommodating memory card A0 cannot be formed in upper region G1.

When memory card A0 is accommodated in card slot 20 having the abovementioned structure, the user bats a leading edge portion of memory card A0 onto the obverse surface of the protruded portion of plate member 22 to push down plate member 22, and inserts memory card A0 into upper region G1. Further, the user continues to insert memory card A0 into fur inner side of card slot 20 until connecting terminal A1 and connecting terminal 24a are surely coupled each other, so as to completely accommodate memory card A0 into card slot 20.

On the other hand, when memory card B0 is accommodated in card slot 20, the user bats a leading edge portion of memory card B0 onto the reverse surface of the protruded portion of plate member 22 to push up plate member 22, and inserts memory card A0 into lower region G2. Further, the user continues to insert memory card B0 into fur inner side of card slot 20 until connecting terminal A1 and connecting terminal 24a are surely coupled each other, so as to completely accommodate memory card B0 into card slot 20.

As described in the above, in card slot 20 of digital camera 200, serving as the second example embodied in the present invention, when accommodating memory card A0, plate member 22 is pushed down so as to form a first space for accommodating memory card A0, while, when accommodating memory card B0, plate member 22 is pushed up so as to form a second space for accommodating memory card B0. Further, when the first space for accommodating memory card A0 is formed in card slot 20, the second space for accommodating memory card B0 cannot be formed, while, when the second space for accommodating memory card B0 is formed in card slot 20, the first space for accommodating memory card A0 cannot be formed.

Accordingly, since thickness X4 of card slot 20 is smaller than the total value of X1+X2, in which X1 is the thickness of memory card A0 while X2 is the thickness of memory card B0, it becomes possible to reduce the thickness of the main body of digital camera 200 thinner than ever, resulting in an improvement of its portability.

Further, since plate member 22 can protect connecting terminal 24b during accommodating action of memory card A0, it becomes possible to avoid the damage and/or abrasion of connecting terminal 24b caused by erroneous contact with memory card A0 when inserting memory card A0 into card slot 20. As well as the above, since plate member 22 can protect connecting terminal 24a during accommodating action of memory card B0, it becomes possible to avoid the damage and/or abrasion of connecting terminal 24a caused by erroneous contact with memory card B0 when inserting memory card B0 into card slot 20.

Still further, since the structure of card slot 20, embodied in the present invention, does not allow to simultaneously accommodate memory cards A0, B0 into it, the UI (User Interface) would be simplified.

The scope of the present invention is not limited to the first and second examples described in the above, which are only concrete examples among the electronic apparatus embodied in the present invention. Further, the detailed structure and the detailed operations of digital camera 100, serving as the first example embodied in the present invention, and digital camera 200, serving as the second example embodied in the present invention, can be varied by a skilled person without departing from the spirit and scope of the present invention.

For instance, a concrete example, embodied in the present invention, is not limited to the digital camera, but other electronic apparatus, for example, small-sized potable apparatus, such as PDA, etc., could be also employed as concrete examples, embodied in the present invention.

Further, although the Memory Stick and the SD card are employed as memory cards A0, B0 in the above explanations, the scope of the present invention is not limited to them. The CF (Compact Flash; a registered trademark), the Smart Media, etc., could be also be employed as memory cards A0, B0, as far as the standards of them are different each other.

Still further, although the two different types of memory devices are exemplified as accessory devices to be accommodated in the digital camera in the first and second embodiments of the present invention described in the foregoing, the scope of accessory devices of the present invention is not limited to such the memory devices. It is also possible to implement the present invention for an embodiment in which at least one of two different types of batteries should be accommodated in the digital camera so as to supply power electronic current from it. For this purpose, the same configuration, as shown in FIGS. 3-5, can be readily applicable for the embodiment of the two different types of batteries by simply replacing the memory card A0 and the memory card B0 with first battery P0 and second battery Q0, after reading the forgoing explanations in regard to the two different types of memory devices. In addition, it is needless to say that the same configuration, as shown in FIGS. 3-5, can be readily applicable for the embodiment of the two different types of accessory devices by simply replacing the memory card A0 and the memory card B0 with first accessory device X0 and second accessory device Y0. Therefore, the detailed explanations in regard to the two different types of batteries and accessory devices are omitted.

According to the present invention, the following effects can be attained.

(1) Since the thickness of the accommodating section (for instance, a card slot) can be reduced thinner than the total thickness of the first memory device (for instance, a first memory card) and the second memory device (for instance, a second memory card), it becomes possible to minimize the size of the accommodating section, resulting in the improvement of the portability of the apparatus, such as a digital camera. Further, since the thickness of the accommodating section can be reduced thinner than the total thickness of the first accessory device (for instance, a first battery) and the second accessory device (for instance, a second battery), it becomes possible to minimize the size of the accommodating section, resulting in the improvement of the portability of the apparatus, such as a digital camera.

(2) It becomes possible to prevent the first memory device and the second memory device or the connecting terminal, etc., equipped in the accommodating section, from damages caused by erroneously accommodating the first memory or the second memory into the wrong accommodating region. Further, it also becomes possible to prevent the first accessory device (for instance, a first battery) and the second accessory device (for instance, a second battery) or the connecting terminal, etc., equipped in the accommodating section, from damages caused by erroneously accommodating the first accessory device or the second accessory device into the wrong accommodating region.

(3) Although a first connecting terminal and a second connecting terminal are provided in the first accommodating region and the second accommodating region so as to be respectively coupled to the first memory device and the second memory device, it becomes possible to prevent the second connecting terminal from wearing off or being damaged by erroneously contacting the first memory device when inserting the first memory device, since the second connecting terminal is protected by the plate member when accommodating the first memory device, and in the same manner, it becomes possible to prevent the first connecting terminal from wearing off or being damaged by erroneously contacting the second memory device when inserting the second memory device, since the first connecting terminal is protected by the plate member when accommodating the second memory device. Further, although a first connecting terminal and a second connecting terminal are provided in the first accommodating region and the second accommodating region so as to be respectively coupled to the first accessory device (for instance, a first battery) and the second accessory device (for instance, a second battery), it becomes possible to prevent the second connecting terminal from wearing off or being damaged by erroneously contacting the first accessory device when inserting the first accessory device, since the second connecting terminal is protected by the plate member when accommodating the first accessory device, and in the same manner, it becomes possible to prevent the first connecting terminal from wearing off or being damaged by erroneously contacting the second accessory device when inserting the second accessory device, since the first connecting terminal is protected by the plate member when accommodating the second accessory device.

Disclosed embodiments can be varied by a skilled person without departing from the spirit and scope of the invention.

What is claimed is:

1. An apparatus, having a function of electronically performing a data transaction with a first memory device and a second memory device and having an accommodating section for accommodating either said first memory device or said second memory device, shapes of said first and second memory devices being different each other, comprising:
a first accommodating region to detachably accommodate said first memory device; and
a second accommodating region to detachably accommodate said second memory device;
wherein said accommodating section includes both said first accommodating region and said second accommodating region, and a part of said first accommodating region overlaps with a part of said second accommodating region.

2. The apparatus of claim 1, further comprising:
an accommodating error preventive element to prevent said first memory device from proceeding into said second accommodating region, and to also prevent said second memory device from proceeding into said first accommodating region, based on dimensional difference between said shapes of said first memory device and said second memory device.

3. The apparatus of claim 1, further comprising:
a plate member to divide said accommodating section into said first accommodating region and said second accommodating region;
wherein, when said first memory device is accommodated in said first accommodating region, said plate member moves in response to an inserting action of said first memory device so as to form said first accommodating region, while, when said second memory device is accommodated in said second accommodating region, said plate member moves in response to an inserting action of said second memory device so as to form said second accommodating region.

4. The apparatus of claim 1,
wherein each of said first memory device and said second memory device is shaped in a card, and, shapes and sizes of said first and said second memory devices are different relative to each other.

5. The apparatus of claim 1, further comprising:
a first connecting terminal to which said first memory device is coupled; and
a second connecting terminal to which said second memory device is coupled.

6. The apparatus of claim 2, further comprising:
a first connecting terminal to which said first memory device is coupled; and
a second connecting terminal to which said second memory device is coupled;
wherein said accommodating error preventive element prevents said first memory device from being coupled to said second connecting terminal, and prevents said second memory device from being coupled to said first connecting terminal.

7. A digital camera, having a function of electronically performing a data transaction with a first memory device and a second memory device and having an accommodating section for accommodating either said first memory device or said second memory device, shapes of said first and second memory devices being different each other, comprising:
a first accommodating region to detachably accommodate said first memory device; and
a second accommodating region to detachably accommodate said second memory device;
wherein said accommodating section includes both said first accommodating region and said second accommodating region, and a part of said first accommodating region overlaps with a part of said second accommodating region.

8. The digital camera of claim 7, further comprising:
an accommodating error preventive element to prevent said first memory device from proceeding into said second accommodating region, and to also prevent said second memory device from proceeding into said first accommodating region, based on dimensional difference between said shapes of said first memory device and said second memory device.

9. The digital camera of claim 7, further comprising:
a plate member to divide said accommodating section into said first accommodating region and said second accommodating region;
wherein, when said first memory device is accommodated in said first accommodating region, said plate member moves in response to an inserting action of said first memory device so as to form said first accommodating region, while, when said second memory device is accommodated in said second accommodating region, said plate member moves in response to an inserting action of said second memory device so as to form said second accommodating region.

10. The digital camera of claim 7,
wherein each of said first memory device and said second memory device is shaped in a card, and, shapes and sizes of said first and said second memory devices are different relative to each other.

11. The digital camera of claim 7, further comprising:
a first connecting terminal to which said first memory device is coupled; and
a second connecting terminal to which said second memory device is coupled.

12. The digital camera of claim 8, further comprising:
a first connecting terminal to which said first memory device is coupled; and
a second connecting terminal to which said second memory device is coupled;
wherein said accommodating error preventive element prevents said first memory device from being coupled to said second connecting terminal, and prevents said second memory device from being coupled to said first connecting terminal.

13. An electronic apparatus, in which an electronic power current is supplied from at least one of a first battery and a second battery, shapes of said first and second batteries being different each other, comprising:
an accommodating section to accommodate either said first battery or said second battery;
a first connecting terminal to which said first battery is coupled; and
a second connecting terminal to which said second battery is coupled;
wherein said accommodating section comprises:
a first accommodating region to detachably accommodate said first battery coupled to said first connecting terminal; and
a second accommodating region to detachably accommodate said second battery coupled to said second connecting terminal; and
wherein a part of said first accommodating region overlaps with a part of said second accommodating region.

14. The electronic apparatus of claim 13,
wherein said electronic apparatus is a digital camera.

15. The electronic apparatus of claim 13, further comprising:
an accommodating error preventive element to prevent said first memory device from proceeding into said second accommodating region, and to also prevent said second memory device from proceeding into said first accommodating region, based on dimensional difference between said shapes of said first memory device and said second memory device.

16. The electronic apparatus of claim 13, further comprising:
a plate member to divide said accommodating section into said first accommodating region and said second accommodating region;
wherein, when said first battery is accommodated in said first accommodating region, said plate member moves in response to an inserting action of said first battery so as to form said first accommodating region, while, when said second battery is accommodated in said second accommodating region, said plate member moves in response to an inserting action of said second battery so as to form said second accommodating region.

17. An electronic apparatus, in which a first accessory device and a second accessory device, shapes of which are different each other, can be selectively and detachably accommodated, said electronic apparatus comprising:
an accommodating section to accommodate either said first accessory device or said second accessory device;
a first connecting terminal to which said first accessory device is coupled; and
a second connecting terminal to which said second accessory device is coupled;
wherein said accommodating section comprises:
a first accommodating region to accommodate said first accessory device coupled to said first connecting terminal; and
a second accommodating region to accommodate said second accessory device coupled to said second connecting terminal; and
wherein a part of said first accommodating region overlaps with a part of said second accommodating region.

18. The electronic apparatus of claim 17,
wherein said electronic apparatus is a digital camera.

19. The electronic apparatus of claim 17, further comprising:
an accommodating error preventive element to prevent said first accessory device from erroneously proceeding into said second accommodating region and being coupled to said second connecting terminal, and to also prevent said second accessory device from erroneously proceeding into said first accommodating region and being coupled to said first connecting terminal, based on dimensional difference between said shapes of said first accessory device and said second accessory device.

20. The electronic apparatus of claim 17, further comprising:
a plate member to divide said accommodating section into said first accommodating region and said second accommodating region;
wherein, when said first accessory device is accommodated in said first accommodating region, said plate member moves in response to an inserting action of said first accessory device so as to form said first accommodating region, while, when said second accessory device is accommodated in said second accommodating region, said plate member moves in response to an inserting action of said second accessory device so as to form said second accommodating region.
